(19) United States
(12) Patent Application Publication
(10) Pub. No.: US 2004/0059614 A1
(43) Pub. Date: Mar. 25, 2004

(54) Customer checkout system

(76) Inventors: Michael Wayne Brown, Georgetown, TX (US); Kumar Ravi, Cedar Park, TX (US); Eduardo N. Spring, Round Rock, TX (US)

Correspondence Address: Marilyn Smith Dawkins, Intellectual Property Law Department, International Business Machines, 11400 Burnet Road, Austin, TX, 78758, US

(21) Appl. No.: 10/232,249

(22) Filed: Aug. 29, 2002

(51) Int. Cl. G06F 17/60

(52) U.S. Cl. 705/8

(57) ABSTRACT

Systems and methods are presented for facilitating customer checkout with an electronic communication between a commercial establishment and a customer of the commercial establishment. A checkout line of the establishment can be monitored with respect to a number of customers in a queue waiting to checkout and for a time spent checking each customer out. In addition, an indication that a customer is intending to checkout can be received via an electronic communication from a network access device. The customer can similarly be notified when to approach a checkout line for checkout, taking into consideration a time to travel to the checkout line from the customer's location and information determined from monitoring the checkout line, thereby minimizing a checkout wait time while the customer is physically present at the checkout line.

### BACKGROUND

The present invention relates generally to an apparatus and method for processing customers through a checkout. In particular, the present invention relates to a system that can schedule a checkout time and/or create a queue for customers and consider the customers according to the schedule.

Checkout lines at a store form when customers converge at a checkout station to complete the purchase of goods that they have selected during a shopping session. The length of a checkout line and an amount of time spent waiting on a checkout line can be subject to variables such as a number of other customers seeking to checkout, a number of available checkout lines, an amount of items being purchased by each customer, the efficiency of each checkout station, and other variables. Time spent waiting on a checkout line is often unproductive and can be frustrating to store customers and lead to an unsatisfactory shopping experience. In addition, time spent by a customer on a checkout line could be time otherwise spent perusing store displays and purchasing additional goods.

Previously stores have attempted to address the problem of long checkout lines by limiting a number of items a customer can purchase on certain checkout lines, increasing a number of available checkout lines, providing teams of checkout employees at each checkout station to expedite checkout processing of each customer, designating cash only checkout lines, and the like. However these measures are often inadequate and inefficient.

Inefficiencies can arise from a store having difficulty anticipating a number of employees needed at a given time in order to be responsive to customers checkout needs. Scheduling too many employees can prove to be unnecessarily expensive to the store in the form of hourly wages and the like. Scheduling too few employees can result in the store being understaffed and cause the store's customers to become impatient and dissatisfied with the store. In addition, designating a maximum number of items that can be purchased on an expedited checkout line can be counter productive to the store's efforts to sell more products and in particular to successfully marketing lucrative impulse purchases, if such purchases would put a customer above a maximum number of items allowed.

Therefore, it would be advantageous to provide a method and apparatus that overcame the drawbacks of the prior art. In particular, it would be desirable to provide a method and apparatus that eliminated, or greatly reduced, time spent on a checkout line. In addition, it would be desirable to provide a method and apparatus that facilitates scheduling an efficient number of employees that can be utilized to provide checkout services.

### SUMMARY

Accordingly, the present invention includes systems and methods for facilitating customer checkout with an electronic communication between a commercial establishment and a customer of the commercial establishment. A checkout line of the establishment can be monitored with respect to a number of customers in a queue waiting to checkout and for a time spent checking each customer out. In addition, an indication that a customer is intending to checkout can be received via an electronic communication from a network access device. The customer can similarly be notified when to approach a checkout line for checkout, taking into consideration a time to travel to the checkout line from the customer's location and information determined from monitoring the checkout line, thereby minimizing a checkout wait time while the customer is physically present at the checkout line.

Implementations can also include providing a customer with a unique customer identification and ordering priority of a checkout queue according to the unique customer identification. The customer can also be directed to a checkout line formed at a particular checkout station.

In another aspect, a confirmation can be transmitted to the customer of a particular checkout time and a verification of the confirmation received. In addition, an indication of a number of items to be checked out by a customer can be received and considered before notifying a subsequent customer when to approach the checkout line for checkout.

In still another aspect, a request can be received from the network access device used by a customer for a particular checkout time. Availability of a checkout station at the requested time can be determined and an indication of whether the requested checkout time is available can be transmitted to the network access device. A network access device can include, for example, a wireless communication device attached to a shopping cart or a personal digital assistant. In addition, a network access device can be any device capable of accessing the Internet, wherein the request for a particular checkout time is received from a network access device accessing the Internet.

In another aspect, a system is disclosed for facilitating customer checkout at a commercial establishment that can include a network access device for transmitting a request for checkout and a computerized server for receiving the request for a checkout. The server or other computerized device can be utilized to create a schedule of customers to be checked out at a checkout line, taking into consideration the received request for checkout and availability of a checkout station capable of fulfilling the received request for checkout. A transmission or other means can be utilized for notifying the customer when to proceed to a checkout station for checkout.

The system can include a customer number, sequential number or other mechanism acting as unique identifier which can be associated with a particular customer. An electronic message or other mechanism can also be utilized to confirm a scheduled customer checkout. A request for checkout can include a preferred time for checkout communicated via a wireless communications device attached to a shopping cart or a personal digital assistant.

Embodiments can also include computer executable program code residing on a computer-readable medium or a data signal implementing the inventive concepts of the present invention. The program code can include instructions for causing a computer to implement various aspects of the invention as described throughout the specification and claims.

Various features and embodiments are further described in the following figures, description and claims.

### DESCRIPTION OF THE DRAWINGS

FIG. 1 illustrates a block diagram illustrating major components included in exemplary embodiments of the invention.

FIG. 2 illustrates components of a system that can be utilized while implementing exemplary embodiments of the present invention.

FIG. 3 illustrates a flow of exemplary steps that can be executed while implementing exemplary embodiments of the present invention.

FIG. 4 illustrates a flow of exemplary steps from the perspective of a shopper that can be executed while implementing embodiments of the present invention.

FIG. 5 illustrates an exemplary data structure that can be utilized in a database implementing embodiments of the present invention.

FIG. 6 illustrates an exemplary graphical user interface that can be utilized in conjunction with the present invention.

### DETAILED DESCRIPTION

The present invention includes apparatus and methods for facilitating efficient checkout of customers purchasing goods. A computerized system can maintain a virtual queue and communicate to a customer, upon request, a time to checkout, such as, for example, scheduling a particular checkout time at a particular store. Scheduling may include a predetermined time for checkout as well as input relating to other variables, exemplary variables can include a proposed number of articles to be purchased, a payment medium, request for assistance bagging, carry out and the like.

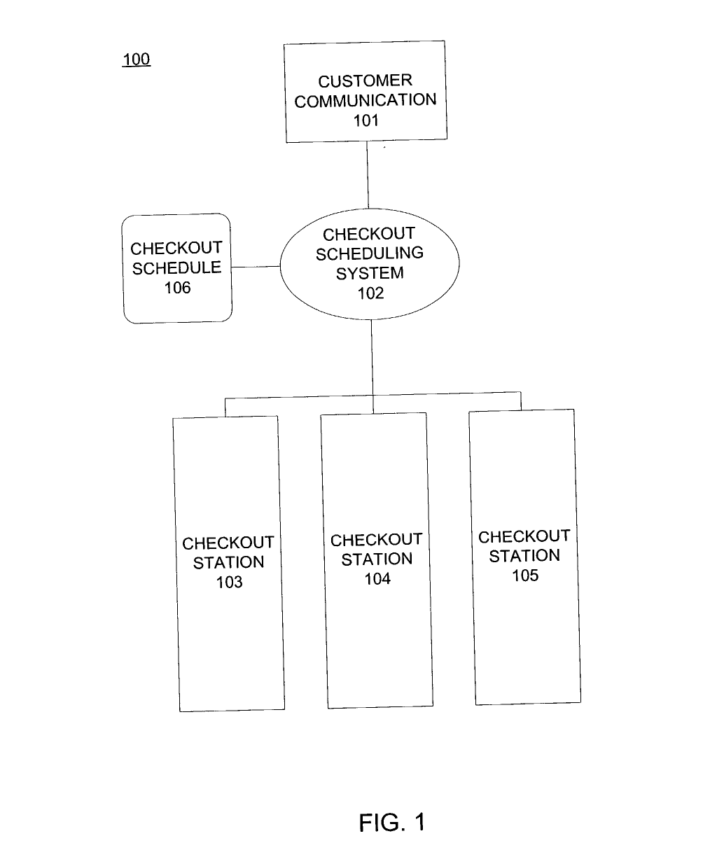

Referring now to FIG. 1, basics components that can be included in some embodiments of the present invention are illustrated. A checkout scheduling system 102 can communicate with a customer via one or more customer communications 101. The customer communications 101 can indicate that a customer will be available for checkout at a particular time. In addition, embodiments can include one or more customer communications 101 indicating an approximate or definitive number of items to be checked out, a type of payment to be rendered, or other pertinent information.

Some implementations can include a wireless device that a customer can receive as they enter a store. For example, a device can be attached to a shopping cart and be programmed to communicate with a checkout scheduling system 102. As a customer enters a store, or while the customer is shopping, the customer can register with the scheduling system 102. Customer registration can include a request for a unique customer identifier (ID) and a particular checkout time. The customer can then approach a checkout station at an appointed time and be readily processed through checkout. Some embodiments can include a customer receiving an indication of a particular checkout station, or checkout personnel, to proceed to. Embodiments can also include details relating to checkout, such as, for example, an estimate of the number of items that will be checked out by the customer, a preferred payment type, whether or not assistance for bagging is preferred and any other details that may facilitate the checkout process.

The scheduling system can associate a unique identifier with each registered customer. Implementations can include any convenient device for uniquely identifying a customer presenting themselves for checkout, such as, for example, assignment of a next sequential number or assignment of a permanent customer number which a customer can utilize any time they patronize a store. The checkout scheduling system can also create a customer checkout schedule 106 that includes checkout times for each customer that registers with the checkout system 102 and respond to each customer that registers with a scheduled checkout time for the shopper. If the customer's preferred checkout time is not available, some embodiments can include the checkout system 102 transmitting one or more alternative times for the customer to checkout. For example, alternative checkout times may include incremental time periods added or subtracted from a requested time, such as, a time that is 5 minutes earlier than the requested checkout time or a time that is 5 minutes later than the requested checkout time. The customer involved can then accept one of the alternative checkout times or suggest a new checkout time. Communications relating to arriving at a mutually acceptable checkout time can be repeated until an acceptable time is determined and transmitted to the customer. The customer can adjust shopping habits and shopping pace such that the customer can be at a checkout station 103-105 at their scheduled time.

The checkout scheduling system 102 can also transmit to, or otherwise notify and update one or more checkout stations 103-105 relating to the checkout schedule 106. For example, the checkout scheduling system 102 can transmit to the checkout station 103-105 which customers are to be checked out at a time, and an order of customer checkout. The customers can be identified via the unique customer ID.

Some embodiments can associate a unique ID with a profile of data descriptive of a customer. A profile can include any data the commercial establishment may be able to ascertain relating to the customer, such as, for example: preferred payment type, bagging or no bagging, candy aisle or no candy aisle, carry out or not, a favorite checkout station location, or other customer related data.

Some embodiments can also include a confirmation of a checkout time at some predetermined time interval prior to the scheduled checkout time. For example, supposing that it takes an average person 1.5 minutes to travel from a furthest point in a store to the checkout station 103-105, a confirmation request message can be transmitted to the customer at a time interval of 3 minutes prior to the scheduled checkout asking for confirmation that the customer will be proceeding up to the checkout station 103-105 to keep the scheduled checkout appointment. Modifications to the checkout schedule 106 can be made responsive to the results of the confirmation.

Variations of embodiments can also include, ascertaining where a customer is located in store and how quickly a customer is likely to traverse the distance to a checkout station. For example, a determination can be made as to which particular aisle, floor, section or other location the customer is located at. In addition, it may be conveyed whether the customer is able bodied and capable of full walking speed, or if the customer is handicapped in some way, or traveling with children or elderly, or any other special circumstance that should be considered to help calculate a checkout time that will allow the customer adequate time to approach a checkout station 103-105.

In another aspect, still further embodiments can include a confirmation message with details relating to the customer's actual shopping experience. For example, a customer may have entered the store intending to buy only 3 items and request a checkout appointment for the 3 items with a checkout time of 7 minutes after arrival. However, while traversing the store, the customer may subsequently decide to buy an additional number of items. This change in number of items can be transmitted to the checkout scheduling system 102 so that those responsible for timely checkouts can adjust resources according to the increased number of items.

Embodiments can also include the checkout system 102 receiving a customer communication 101 to schedule a checkout time from a location remote to the store in which the customer is requesting a checkout schedule appointment. For example, a customer can access a checkout scheduling system via the Internet, via a telephone touchtone activated system, via a voice call or other communications network. The customer can convey their request for a particular time of checkout and negotiate a specific checkout time. The checkout scheduling system can transmit to the customer a unique identifier and a checkout schedule 106 reflecting the negotiated checkout time and date.

Checkout appointments can be allocated according to any criteria that fit a business model of a store setting in which it will be implemented. For example, some embodiments may implement a first come first serve priority scheme for scheduling appointments. In addition, some embodiments can include checkout appointments for checkout times and dates, or days of the week, according to some other scheduling priority criteria. For example, appointments for premium checkout schedule times that are most in demand may be allocated according to a customer rating, an estimated amount of a purchase, a minimum amount of a purchase, a volume of business conducted with a requesting customer, or other criteria. Accordingly, it is within the scope of this invention to reserve some checkout schedule appointment times for commercial customers or other premium rated customers.

It is also within the scope of this invention to sell particular checkout appointments, such as those during time slots on a checkout schedule 106 that are most desirable. For example, a premium checkout appointment can be sold for a set fee, auctioned through a bidding process, reserved at an annual rate, or other valuation scheme. As such, it is feasible that some embodiments can include conveying, bartering, selling, or otherwise transferring for value, or for free, a checkout appointment at a specific store. In particular it may be useful, and valuable, to be able to pre-arrange a checkout schedule 106 appointment on certain calendar days popular for shopping, such as, for example, the day after Thanksgiving, or Christmas Eve. From the perspective of the customer, the customer may be much more willing to brave a crowded shopping situation with the knowledge that the customer has a guaranteed checkout appointment. From the perspective of a store or retail chain, the store or retail chain can have the assurance of a steady flow of customers, be able to receive additional value in the prices received for premium appointments, attract a more affluent customer for whom time is relatively more valuable, be able to staff a store according to scheduled volume or special requests made by customers scheduling a checkout appointment and other advantages.

In another aspect, embodiments of the present invention can include a store scheduling a checkout appointment being contractually held to keeping the appointment with specified consequences should the store not be able to provide a checkout service at an agreed to time and date. For example, if a store cannot complete a checkout appointment within a predetermined time period of the checkout time, the store may be required to discount the purchases made by the scheduled customer, or provide some other compensation.

Still other embodiments can include an inquiry by a customer for a time frame during which the store statistically has a relatively low volume of business which may result in a more pleasant shopping experience, such as, for example: on a Monday afternoon, or on a Sunday morning.

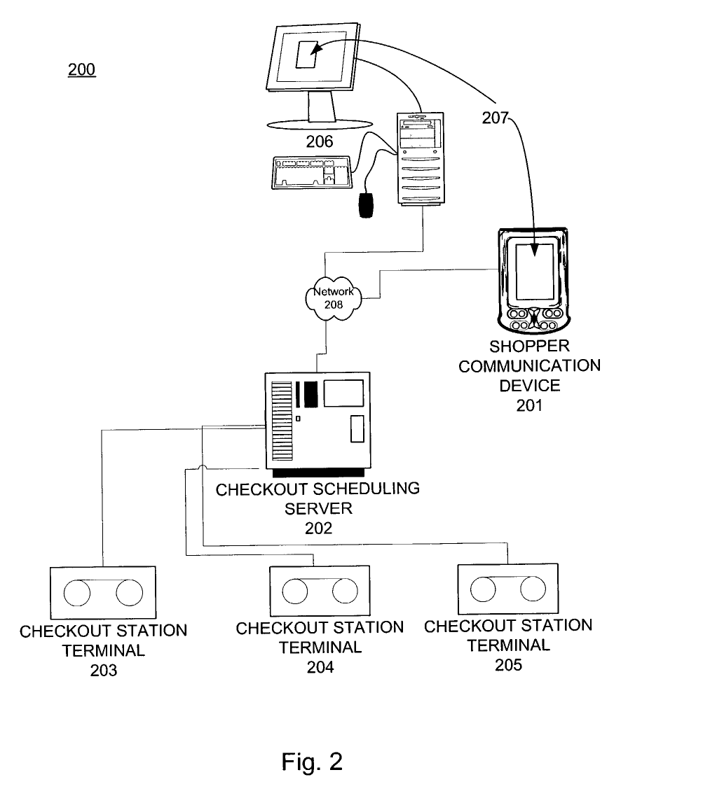

Referring now to FIG. 2, a network diagram illustrating one embodiment of the present invention is shown 200. A checkout scheduling system 102 can include a computerized checkout scheduling server 202 accessible via a wireless or other communications network 201, such as the Internet, a private network, a local area network (LAN) or direct link. A customer or other party interested in scheduling a checkout appointment on a checkout schedule 106 can use a computerized device 204-207 to receive, input, transmit or view information processed in the checkout scheduling server 202. A shopper communication device 201 or other network access device 206 can be utilized to interact with and receive, input, transmit or view information processed in the checkout scheduling server 202. A protocol, such as the transmission control protocol Internet protocol (TCP/IP) can be utilized to provide consistency and reliability.

A shopper communication device 201 or other network access device 206 can be utilized to access the checkout scheduling server 202. The shopper communication device 201, such as a wireless personal communications device or other network access device 206 can include a processor, memory, user input device, such as a touch screen or keyboard and/or mouse, and a user output device, such as a display screen and/or printer. The computing devices 201 206 can communicate with the checkout scheduling server 202 to access data and programs stored on the checkout scheduling server 202, or to run applications hosted on the checkout scheduling server 202. The computing device 201 206 may interact with the checkout scheduling server 202 as if the checkout scheduling server 202 were a single entity in the network 208. However, the checkout scheduling server 202 may include multiple processing and database sub-systems, such as cooperative or redundant processing and/or database servers that can be geographically dispersed throughout the network 208.

The checkout scheduling server 202 can include one or more databases storing data relating to checkout schedule 106, such as a listing of customers, availability of checkout station terminal 203-205, criteria for obtaining a scheduled checkout, or other data. The checkout scheduling server 202 may interact with and receive data from and transmit data to various computing devices 201 206. Gathered data can be received via electronic input and structured according to date and time, customer, store, checkout station, or other criteria. It can also be utilized to conduct sales or market analysis, trends, patterns or other analysis.

Typically a customer or other interested party, will access the checkout scheduling server 202 using client software executed at a computing device 201 206. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from a checkout scheduling server 202 to a computing device 201 206 and executed at the computing device 201 206. Other implementations can include proprietary software installed from a computer readable medium, such as a DVD or CD ROM. Embodiments of the invention may therefore be implemented in digital electronic circuitry, computer hardware, firmware, software, or in combinations of the above. As such, some apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

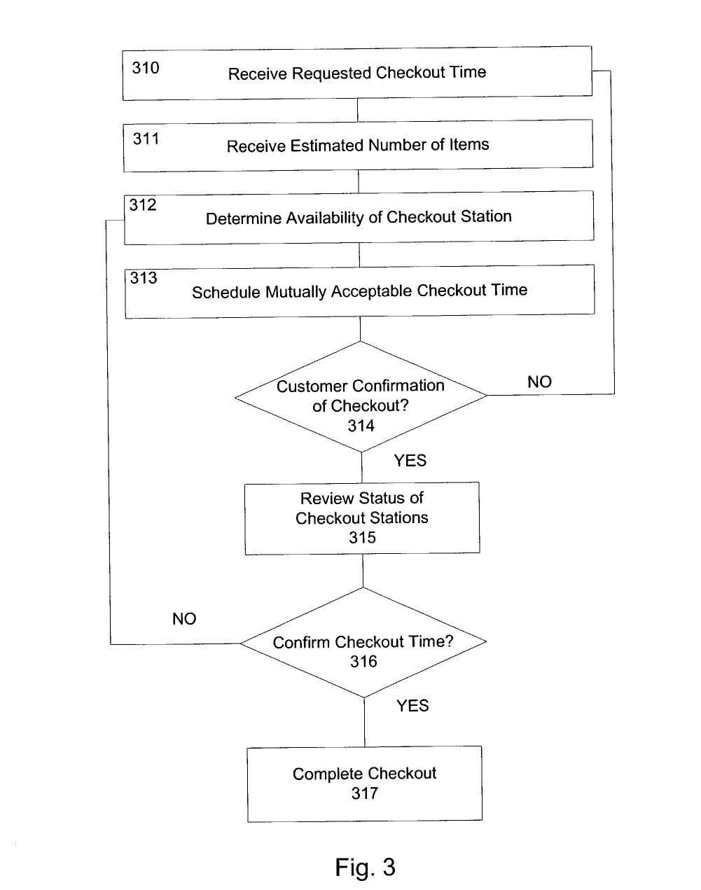

Referring now to FIG. 3, exemplary steps that can be implemented in some embodiments of the present invention are illustrated. A checkout scheduling system 102 can receive a request for a checkout time 310 and in some implementations also receive an estimated number of items that will be checked out 311. The request can be received, for example via an electronic access to the checkout scheduling server 202. The checkout scheduling system 102 can determine the availability of a checkout station 103-105 at the requested time 312.

Determination of the availability of a checkout station 103-105 can be facilitated by a checkout schedule 106 which can calendar checkout events for each checkout station 102-105 and/or feedback from checkout stations 103-105 relating to progress in checking out customers, such as whether the checkout stations are on schedule, behind schedule, or even ahead of schedule. In addition, the checkout stations 103-105 can provide such data as an average number of items, the average time to checkout a customer, statistics or other analysis or data relating to payment type, time associated with processing a payment type, or other related data.

A checkout time mutually acceptable to the customer and to the checkout scheduling system can be scheduled. Prior to checkout, embodiments can include a confirmation with the customer and the checkout scheduling system 102 of the ability to keep the scheduled appointment 314. Confirmation 315 can include ascertaining the availability of a checkout station 103-105 to timely checkout the customer, as well as ascertaining that the customer has been able to complete their shopping selections. If an original request cannot proceed to a confirmation 315 of a mutually acceptable checkout time, the process can loop back to receiving a requested checkout time 310.

An affirmative confirmation can proceed to completing a checkout 317. If confirmation can not be completed, the process can loop back to the step of determining next availability of a checkout station 103-105. Embodiments can also include processing a next queued customer and allowing an originally queued customer a certain grace period to present themselves for checkout before forfeiting their checkout priority. For example, a grace period of several minutes, or 1 or 2 places in the priority queue.

Confirmation can also include a dialogue between a customer and a checkout scheduling system 102, including, if appropriate an operator of the checkout scheduling system 102. For example, a customer may indicate that they are not ready to proceed to checkout and that they need additional shopping time. The checkout scheduling system 102 can reschedule the customer to another position in the checkout queue, such as, for example: to a position later in the queue, such as 3 positions later; to a later time; such as, 15 minutes later, to a checkout station 103-105 that provides additional services, such as carrying purchased items to a waiting automobile; to a checkout station 103-105 offering a preferred payment type, such as a credit card payment; or other change in a checkout queue.

In addition, a dialogue can include a request for a candy aisle, or no candy aisle, or a checkout station that will provide cigarettes or not provide cigarettes, or any other vended items, such as magazines.

A two-way communication can also include other types of information, such as an average wait time from request to checkout until an actual checkout, or a list of alternatives for checking out, such as all service options or payment types. Service types can include the ability to weigh items, to gift wrap items, to have items shipped or delivered or any other service that may be offered by a commercial entity. A location of a nearest checkout can also be conveyed, or a location of a next available checkout station, or a list of available checkout stations ordered by availability. For example, in a multi-floor location, a checkout station on the third floor may be available sooner than a checkout station on a first floor.

A confirmation dialogue can also include notifying a customer if a particular checkout station 103-105 becomes unavailable, such as if an operator changes shift or otherwise is unable to remain at the checkout station 103-105.

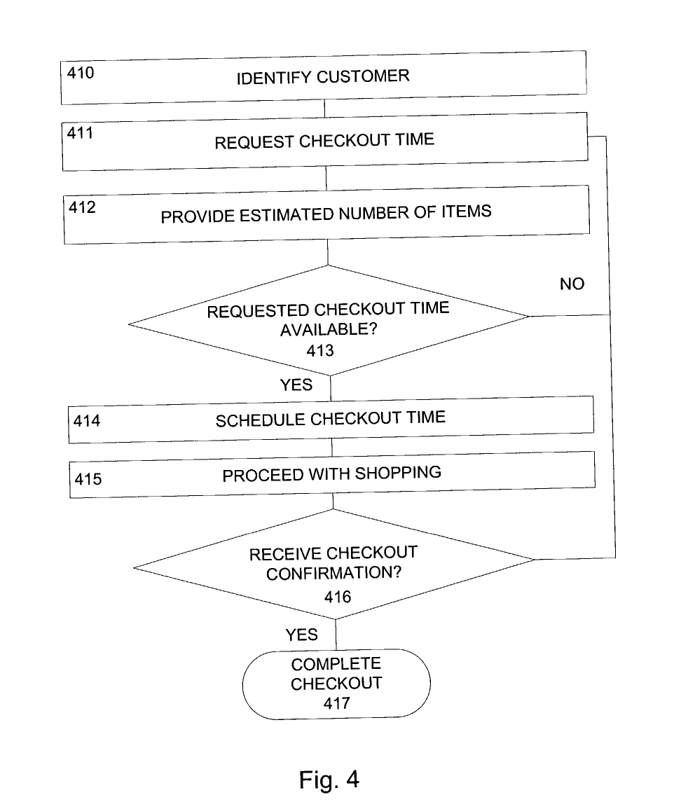

Referring now to FIG. 4, exemplary steps are illustrated which can be implemented from the perspective of a requester of a checkout implementing some embodiments of the present invention. A requestor can identify a customer 410, such as, for example by contacting the checkout scheduling system 102 and receiving a customer ID, or inputting a customer ID previously assigned to the customer. A checkout time can also be requested 411. Different embodiments can include, for example: allowing a customer to request a specific checkout time; assigning a checkout item that defaults at a predetermined period of time from the request, such as 30 minutes from the request; scheduling the checkout time at a period of time derived from statistics of gathered from previous shopping experiences, such as an average shopping period for shoppers at a similar time of day and similar day of the week; assigning a next available checkout time, or other method.

Some embodiments can allow a customer to provide an estimated number of items which will be checked out 412.

If a requested time is available 413, the checkout time can be scheduled 414, and the customer can proceed with shopping 415. If the requested time is not available, the process can loop back to the step of requesting a checkout time 411. Some embodiments can include a customer receiving a checkout confirmation 416. With confirmation, the checkout can be completed 417. If the confirmation is not confirmed, a new checkout time can be requested 411.

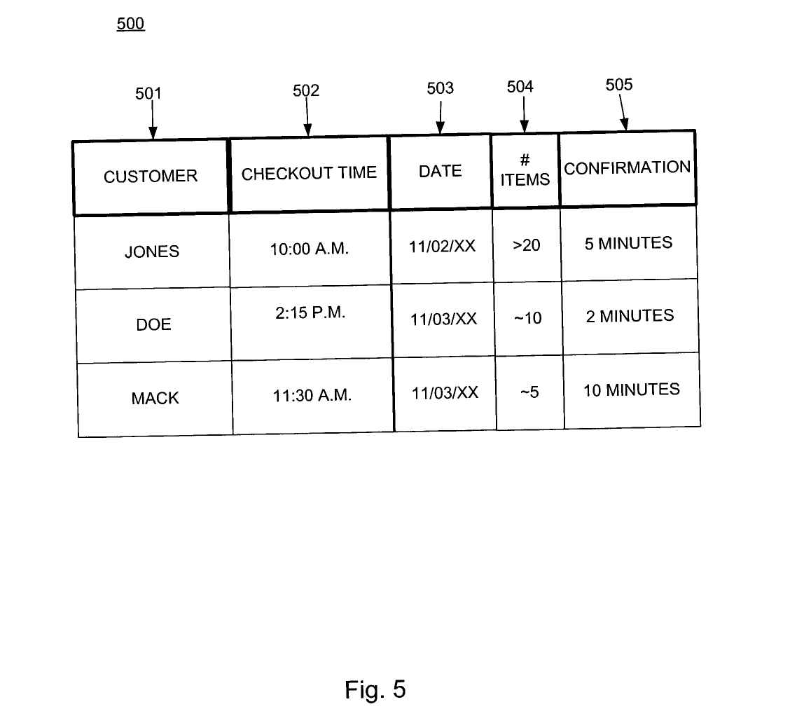

FIG. 5 an exemplary data structure that can be utilized in a database implementing some embodiments of the present invention is illustrated. The database structure 500 can include a customer data field 501, a checkout time 502, a date field 503, a number of items data field 504, a confirmation data field 505 and any other data field that may be useful to implementing a scheduled checkout time.

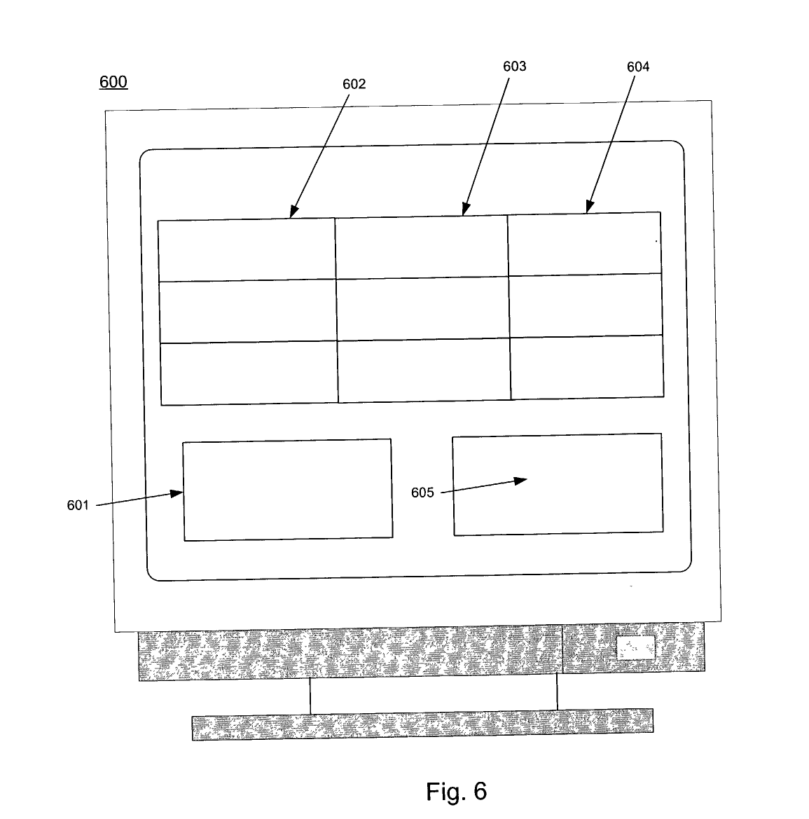

Referring now to FIG. 6, an exemplary GUI 600 for presenting various aspects of the present invention on a display, such as a display utilized in conjunction with a shopper communication device 210 or a network access device 206, is illustrated. The GUI 600 can include geographic areas of a user interface containing customer identifiers 602, such as, for example, a permanent customer number or a temporary sequential assignment. Additional areas can include a number of items to be checked or actually checked out depending on whether the checkout has been consummated 603, a time scheduled for checkout and/or actual checkout time 604, any related notations, such as, for example special sales being conducted in the store while the customer is present 601 or other functional area. Some embodiments can include an area for non-checkout related services, such as a deli counter service, or a specific type of sales help.

A number of embodiments of the present invention have been described. Nevertheless, it will be understood that various modifications may be made without departing from the spirit and scope of the invention. For example, some embodiments can include the ability to request additional services in order to allow the store to accommodate fulfillment of the customer's request, such as, a request for a particular checkout person, a request for gift wrapping, a request for shopping assistance or other request which can be facilitated by allowing the store to anticipate the need and schedule the requested service. Still other requests that are included in the scope of this invention, such as, for example, an interactive queue for other services available at a commercial establishment, such as for example a deli counter, a butcher, a tailor, a specialized sales person, or other service. Accordingly, other embodiments are within the scope of the following claims.

What is claimed is:

1. A method for enabling an electronic communication between a commercial establishment and a customer of the commercial establishment, the method comprising:
monitoring at least one checkout line of the establishment with respect to a number of customers in a virtual queue waiting to checkout and for an estimated time spent checking each customer out;
receiving, from a network access device used by a customer of the commercial establishment, an indication that the customer is intending to checkout; and
notifying the customer when the customer can approach a checkout station for checkout taking into consideration a time to travel to the checkout line from the customer's location and information determined from monitoring the checkout line, thereby minimizing a checkout wait time while the customer is physically present at the checkout line.

2. The method of claim 1 further comprising the steps of:
providing to the customer a unique customer identification; and
ordering priority of a checkout queue according to the unique customer identification.

3. The method of claim 1 further comprising the step of directing the customer to a particular checkout station.

4. The method of claim 1 further comprising the steps of:
transmitting to the customer a confirmation of a particular checkout time; and
receiving a verification of the confirmation.

5. The method of claim 1 further comprising the steps of:
receiving an indication of a number of items to be checked out by the customer; and
considering the number of items to be checked out by the customer when notifying a subsequent customer when to approach the checkout line for checkout.

6. The method of claim 1 additionally comprising the steps of:
receiving, from the network access device used by a customer a request for a particular checkout time; and
transmitting to the network access device an indication if the requested checkout time is available.

7. The method of claim 6 additionally comprising the step of determining the availability of a checkout station at the requested time.

8. The method of claim 1 wherein the indication that the customer is intending to checkout is received from a network access device comprising a wireless communication device attached to a shopping cart.

9. The method of claim 1 wherein the indication that the customer is intending to checkout is received from a network access device comprising a personal digital assistant.

10. The method of claim 6 wherein the request for a particular checkout time is received from a network access device accessing the Internet.

11. A system for facilitating customer checkout at a commercial establishment, the system comprising:
a computerized server for receiving the request for checkout from a network access device;
a means for creating a schedule of customers to be checked out at a checkout station; and
a means for notifying the customer when to proceed to the checkout station for checkout.

12. The system of claim 11 wherein the request for checkout comprises a preferred payment type.

13. The system of claim 11 wherein the network access device comprises a wireless communications device associated with a shopping cart.

14. The system of claim 11 wherein the network access device comprises a personal digital assistant.

15. Computer executable program code residing on a computer-readable medium, the program code comprising instructions for causing a computer to:
receive a request for a checkout at a commercial establishment, wherein the request indicates a preferred time for checkout;
create a checkout schedule taking into consideration a checkout queue for at least one checkout station and the preferred time for checkout; and indicating details of the checkout schedule to the customer and the checkout station.

16. The computer executable code of claim 15 wherein the computer executable code additionally comprises instructions for causing the computer to:
transmit a confirmation of a scheduled checkout; and
receive a verification of the confirmed scheduled checkout.

17. The computer executable code of claim 15 wherein the computer executable code additionally comprises instructions for causing the computer to:
receive details of additional services requested at checkout.

18. The computer executable code of claim 15 wherein the computer executable code additionally comprises instructions for causing the computer to:
receive an estimated number of items to be checked out.

19. The computer executable code of claim 15 wherein the computer executable code additionally comprises instructions for causing the computer to:
receive a request to re-schedule a scheduled checkout; and
transmit a response to the reschedule request.

20. A method for communicating with a commercial establishment, the method comprising:
transmitting an indication of preferences related to checkout;
receiving an indication of a scheduled time suitable to proceed to checkout; and
transmitting an indication of an acceptance of the scheduled time suitable to proceed to checkout.

21. The method of claim 20 additionally comprising the step of receiving an indication of a checkout station to proceed to for checkout.

22. The method of claim 20 additionally comprising the step of transmitting at least one of a) an estimated number of items to be checked out, b) a preferred payment type and c) additional service requested at checkout.

23. A system for communicating with a commercial establishment, the system comprising:
a network access device comprising a processor and storage medium;
executable software operative with the processor to enable the network access to:
transmit an indication of preferences related to checkout;
receive an indication of a scheduled time suitable to proceed to checkout; and
transmit an indication of an acceptance of the scheduled time suitable to proceed to checkout.

24. The system for communicating with a commercial establishment of claim 23 additionally comprising:
a means for transmitting at least one of a) an estimated number of items to be checked out, b) a preferred payment type and c) additional service requested at checkout.

25. The system for communicating with a commercial establishment of claim 23 additionally comprising a means for receiving an indication of a checkout station to proceed to for checkout.
